(19) United States
(12) Patent Application Publication
(10) Pub. No.: US 2004/0076178 A1
(43) Pub. Date: Apr. 22, 2004

(54) Protocol conversion

(76) Inventor: Laurence Jon Botton, Woodbridge (GB)

Correspondence Address: Nixon & Vanderhye, 8th Floor, 1100 North Glebe Road, Arlington, VA, 22201-4714, US

(21) Appl. No.: 10/471,409

(22) PCT Filed: Mar. 21, 2002
(86) PCT No.: PCT/GB02/01358

(30) Foreign Application Priority Data
Mar. 29, 2001 (EP) 01302997.0

(51) Int. Cl. H04J 3/22

(52) U.S. Cl. 370/466; 370/395.3

(57) ABSTRACT

A CTI system comprising a CTI-enabled switch, a CTI controller, and a protocol converter for converting between the proprietary protocol used by the CTI-enabled switch and the CSTA protocol used by the CTI controller, wherein the protocol converter includes a counter which is triggered by each message arriving from the switch. The protocol converter associates the respective count with the received message and with its corresponding converted message and stores the messages in a log. Each stored message also has an associated protocol type identifier assigned by the protocol converter to distinguish between the two types of messages. The protocol converter also stores descriptive statements for each message and for various related switch activities, each statement having an associated type identifier and a ranked importance identifier. Reports can be run on the log to find all entries relating to a given call ID and having the highest rank importance identifier. This greatly enhances the readability of the report, and the respective counts provide immediate visibility of the sequence of the messages in the report.

The present invention relates to a method of and an apparatus for converting messages between a first protocol and a second protocol, and particularly but not exclusively to the conversion of messages passing between a computer telephony integration (CTI) enabled switch operating in accordance with a first protocol and its CTI controller operating in accordance with a second protocol.

In accordance with a first aspect of the present invention there is provided a protocol converter for converting messages between a first protocol and a second protocol, the protocol converter comprising converter means responsive to receipt of a first type message in accordance with the first protocol for converting the first type message into a corresponding second type message in accordance with the second protocol, means for generating for the received first type message a respective message receipt identifier, and wherein the converter means is further responsive to said receipt to associate the corresponding second type message with that respective message receipt identifier.

Preferably, the converter means is further responsive to said receipt to associate the received first type message with that respective message receipt identifier.

The converter means may be further responsive to said receipt to associate the received first type message with a first message type identifier, and the corresponding second type message with a second message type identifier.

Preferably, the converter means is further responsive to said receipt:

to generate a plurality of information statements, one of said plurality of information statements being a high level description of the overall nature of the first type message and being of highest importance and the or each other information statement being a high level description of a respective component part of the received first type message and being of lower importance; and

to associate with each information statement a respective importance value determined in accordance with predetermined importance criteria.

A protocol converter in accordance with this first aspect may further comprise a log, and the converter means may be further responsive to said receipt to store in the log the received first type message, the corresponding second type message, and, as the case may be, any information statements, together with, as the case may be, any associated respective message receipt identifier, any respective message type identifier and any respective importance value.

Preferably, the converter means performs the association of the respective generated message receipt identifier with the corresponding converted message by appending an additional field to the corresponding converted message and inserting the respective generated message identity into that additional field.

Preferably, the identifier generator means is arranged for generating the message receipt identifiers in two-part form, one of said parts being a protocol converter-related identifier, and the other of said parts being a received message-related identifier.

In accordance with a second aspect of the present invention there is provided a computer telephony integration (CTI) system comprising a CTI-enabled switch, a CTI controller, and a protocol converter in accordance with this first aspect disposed to perform protocol conversion upon messages passing between the CTI-enabled switch and the CTI controller, and wherein the CTI-enabled switch operates in accordance with said first protocol, and the CTI controller operates in accordance with said second protocol.

In accordance with a third aspect of the present invention there is provided a method of converting messages between a first protocol and a second protocol, comprising the steps of:

responding to receipt of a first type message in accordance with the first protocol by converting the first type message into a corresponding second type message in accordance with the second protocol;

generating for the received first type message a respective message receipt identifier; and

associating the corresponding second type message with that respective message receipt identifier.

Preferably, there is included the further step of associating the received first type message with that respective message receipt identifier.

There may be included the further step of associating the received first type message with a first message type identifier, and the corresponding second type message with a second message type identifier.

Preferably, there are included the further steps of:

generating, in response to said receipt, a plurality of information statements, one of said plurality of information statements being a high level description of the overall nature of the first type message and being of highest importance and the or each other information statement being a high level description of a respective component part of the received first type message and being of lower importance; and

associating with each information statement a respective importance value determined in accordance with predetermined importance criteria.

There may be included the further steps of storing in a log the received first type message, the corresponding second type message, and, as the case may be, any information statements, together with, as the case may be, any associated respective message receipt identifier, any respective message type identifier and any respective importance value.

Preferably, the step of associating the respective generated message receipt identifier with the corresponding converted message comprises appending an additional field to the corresponding converted message and inserting the respective generated message identity into that additional field.

The step of generating a respective message receipt identifier may provide the identifier in two-part form, one of said parts being a protocol converter-related identifier, and the other of said parts being a received message-related identifier.

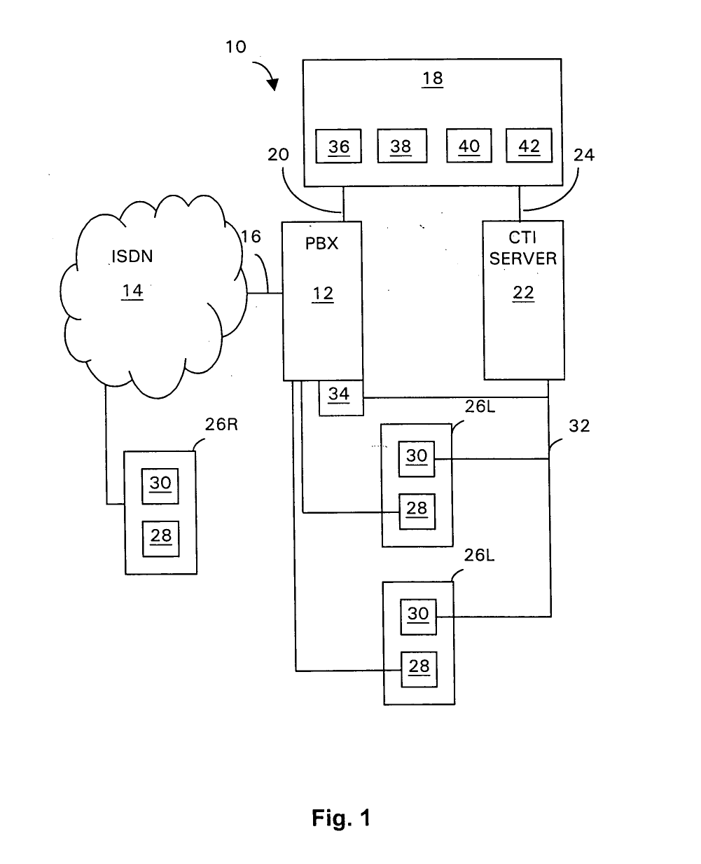

A specific embodiment of a CTI system employing protocol conversion in accordance with the present invention will now be described by way of example with reference to FIG. 1 which is a block diagram of the CTI system.

In this description the following acronyms are used:—

CLI—Calling Line Indication, also known as Calling Line Identity,

y CSTA—Computer Supported Telecommunications Applications,

y CTI—Computer Telephony Integration,

y DN—Directory Number,

DOT—Distributed Office Telephony,

y ID—Identity

y ISDN—Integrated Services Digital Network,

IP—Internet Protocol,

y LAN—Local Area Network,

y PBX—Private Branch Exchange,

RAM—Random Access Memory,

ROM—Read Only Memory.

In FIG. 1 there is shown a CTI system 10 comprising a CTI-enabled PBX 12, in the form of a Meridian Norstar, available from Nortel Networks Limited and constituting a switch of the present invention, connected to an ISDN 14 via an ISDN primary rate link 16; a switch driver 18, constituting a protocol converter of the present invention, connected to the PBX 12 via a data link 20 and to a CTI server 22 via a data link 24.

The PBX 12 communicates with the switch driver 18 in accordance with a proprietary protocol known as Meridian Link from Northern Telecom, and the switch driver 18 communicates with in accordance with the CTI server 22 in accordance with a protocol known as Computer Supported Telecommunications Applications (CSTA). There are other proprietary CTI protocols, and several “open”, or proposed standard, CTI protocols, including CSTA, but the performance of the present invention is not dependent upon the use of any particular CTI protocol.

The CTI system 10 also comprises a plurality of work desks, also known as workstations, 26R, situated remotely from the PBX 12, and a plurality of work desks 26L, situated locally to the PBX 12, each work desk having a respective telephone terminal 28R, 28L, referred to hereinafter as a telephone, and a respective computer terminal 30R, 30L, referred to hereinafter as a CTI client, or just client. For convenience, only one remote work desk 26R and only two local work desks 26L are shown.

The CTI server 22 and the local CTI clients 30L are directly connected to a LAN 32, and each remote CTI client 30R is indirectly connected to the LAN 32 via the ISDN 14 when a user at the respective remote work desk 26R makes a call to a predetermined destination number for access to the LAN 32. The PBX 12 receives that call and connects it to a corresponding port which is connected to the LAN 32 via an ISDN/LAN bridge 34. In this description, the terms user and workgroup member are used interchangeably and synonymously.

The switch driver 18 comprises a protocol converter 36 for performing the actual protocol conversion, a 32 bit counter 38, constituting a message identity generator of the present invention, a call record store 40 and a driver log 42. The protocol converter 36 is arranged to generate respective entries in the driver log 42. These entries comprise the various messages that it receives and sends, together with associated information entries which it derives from those messages. The protocol converter 36 is arranged, in accordance with the present invention, to add to those entries respective type identifiers and importance identifiers, and well as the message identities, i.e. numbers, generated by the counter 38.

The type identifiers are “M” for messages transmitted between the switch driver 18 and the PBX 12, and for their associated information entries; and “m” for messages transmitted between the switch driver 18 and the CTI server 22, and for their associated information entries.

The importance identifiers are “0”, “1” and “2”, which have different meanings for the two types, M and m. For type M and m entries, the identifier “0” means a synopsis in natural language for human readability. For type M entries, the identifier “1” means a message expressed in hexadecimal and containing a large amount of switch-related information indicative of various switch actions and switch conditions; and for type m entries, the identifier “1” means a message in natural language for human readability and containing switch-related information such as “DN:2661”, i.e. directory number 2661, and “swMsgRefID:0x0011”, which is a numerical switch message reference identity. For type m entries, the identifier “2” means an entry relating to an action or condition of the switch at a low level of interest. The driver log 42 can be accessed by these type and importance identifiers so as to present to an enquirer, e.g. a system operator, only entries in which he is interested, e.g. only the M0 and m0 entries in human readable form.

For the purposes of the present application, it will be assumed that the CTI server 22 runs a ClickDial application, and that all the users are ClickDial-enabled at their clients. If the reader requires further details, he is referred to the article “ClickDial, Web-Enabled CTI”, by Robert Brockbank, Gary Crook and Derek Emerson, British Telecommunications Engineering, April 1999.

An example will now be described of the call processing stages of a CTI call requested by user A at telephone 2661 to user B at telephone 2660, with the help of a printout of the driver log entries relating to that call. Some of the entries are referred to in the following description and these entries are labelled, in this description only and not in the driver log, with “E” numbers, e.g. “E5”, to help in finding the entry within the printout. Also, some of the entries comprise a plurality of lines, and where a particular line within an entry is referred to, those lines are labelled with both “E” and “L” numbers, e.g. “E5L6” would denote the sixth line in the entry labelled “E5”.

Stage one.

| | |
|---|---|
| | [HTD] <-------- Incoming -------- |
| E1 | [HT_MsgTypeRequest] { |
| | [HT_TokenVersion:“HT CSTA 1.0”] |
| | [HT_TokenRequest:HT_RequestMakeCall] |
| | [HT_TokenRequestID:919191] |
| | [HT_TokenCallingDevice:“2661”] |
| | [HT_TokenCalledDevice:“2660”] |
| | } |
| | [HTD] <-------- Incoming -------- |
| | :m1: VVVVVVVVVVVVVVVVVVVVVVVVVVVVVVVVVVVVVVVVVVVVVVV |
| E2 | :m1: VVVV Application-NewMsgTimeStamp:13:47:38 2001-02-09 VVVV |
| E3 | :m1: DEVICE - DeviceSet:DN:2661 ReqID:2, swMsgRefID:0x0011. |
| E4 | :M0: **** Host-->Link: Request - ‘MakeCall’ (2661, 2660) **** |
| | :M1: ------------------------------------------------------------------------- |
| | :IE: ‘MakeCall’ |
| | :IE: 0xFF ‘Message Header’: MsgLen 29, AssocID 16, Ref 0x0011 |
| | :IE: 0x30 ‘Origination Address’: 2661 (Type: 0x08:‘Internal’) |
| | :IE: 0x31 ‘Destination Address’: 2660 (Type: 0x08:‘Internal’) |
| | :IE: Dumping: IE 0x34, ‘Call Manner’, (Len: 3) 0x34 03 03 |
| E5 | :M1: 0xFF 0A 00 1D 10 00 11 08 01 F0 30 08 7A 08 32 36 36 31 31 08 |
| | 00 08 32 36 36 30 34 03 03 |
| | :m2: INIT - mlProcessSocket: got input |
| | :M1: |

E1 E2 E3 E4 E5

To arrive at this stage one, the user A would have accessed a directory, using his computer 30, found the name of user B, and clicked on the associated ClickDial button. His computer 30 would have sent a ClickDial cookie and user B's telephony number (2660) to the ClickDial application running on the CTI server 22. The ClickDial application would have retrieved from a registration store user A's telephone number (2661) and have generated the CSTA message “RequestMakeCall”, labelled E1, and sent it to the switch driver 18. Upon receipt of this CSTA message, the protocol converter 36 has, in accordance with its operating program, stored the received message in the driver log 42; run an application (Application-NewMsgTimeStamp) for obtaining a time stamp for the receipt of that received CSTA message, and stored an associated “m1” entry, labelled E2, with that time stamp; accorded that received CSTA message the message type and importance “m1”, and stored an associated “m1” entry, labelled E3, containing inter alia the calling DN and a switch message reference ID; converted that received CSTA message into the corresponding message “M1” Meridian Link format (in hexadecimal) and sent it to the PBX 12, stored an associated “M0” MakeCall entry, labelled E4, containing in plain language the text “Host—>Link: Request-‘MakeCall’ (2661, 2660)”; and stored the “M1” message as sent to the PBX 12, labelled E5, together with a set of information elements, IE, giving information on the content of that “M1” message.

The driver log 42 will contain many thousands of entries, and even if a report is run on the log to extract only selected entries, there will still be a very large number of entries in such a report. To assist in the reading of reports, respective additional features have been included, for example for the received CSTA message in stage one, there is an additional “m1” entry comprising a full line of seventy three “V”s, but for convenience herein a full line comprises fewer than this, the “m1” entry for the Application-NewMsgTimeStamp contains a header and a tailer each comprising twelve “V”s, of which for convenience only four are shown, the “M0” entry for MakeCall contains a header and a tailer each comprising four “*”s, there is an additional “M1” entry comprising a number of “-”s, to denote the start of the IE entries relating to the “M0” entry MakeCall. Other such distinguishing sets of characters will be seen in the subsequent stages of the call processing.

The message (E5) sent to the PBX 12, see its associated “IE” entries, has a Message Header “0xFF”; its fourth byte is the value of the “MsgLen”, i.e. 29; its fifth byte is the identity, “AssocID 16”, for the protocol converter 36 in order that this particular protocol converter can be distinguished from other such protocol converters also connected to the PBX 12; its sixth and seventh bytes are the value of the “swMsgRefID:0x0011”; the eleventh and twelfth bytes define an eight byte field containing an “08” byte denoting “Internal” telephone and also four bytes “32 36 36 31” denoting the “Origination Address” 2661; the nineteenth and twentieth bytes define an eight byte field containing the corresponding information “Internal” and “Destination Address” 2660. The message contains other bytes denoting other information, but these will not be described as they are not germane to the present invention.

It will be noted that as this is the start of the call, neither the message (E1) nor the message (E5) contains a call ID because the PBX 12 will allocate the call ID in response to receipt of the message (E5): the first message received by the protocol converter 36 containing the call ID for this call will be the hexadecimal message (E8) received in Stage two described below. Furthermore, the protocol converter 36 will not allocate a message identity to the messages (E1 and E5) since these will not be retrieved by a report run on the driver log 42 in respect of the call ID.

Stage two.

| | |
|---|---|
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| E6 | :M1: e5 \hat{ }\hat{ }\hat{ }\hat{ }\hat{ } Link-NewMsgTimeStamp:13:47:38 2001-02-09 \hat{ }\hat{ }\hat{ }\hat{ }1.1*.0*\hat{ } |
| | :M1: \hat{ }\hat{ }\hat{ }\hat{ }\hat{ } Creation:13:44:33 2001-02-09, Connection:13:44:43 2001-02-09 \hat{ }\hat{ }\hat{ }\hat{ }\hat{ } |
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :IE: ‘StatusChange’ |
| | :IE: 0xFF ‘Message Header’: MsgLen 36, AssocID 16, Ref 0x0000 |
| | :IE: 0x37 ‘This Device TN’: 0x048A (004 0 02 10) |
| | :IE: 0x36 ‘This Device DN’: 2661 (Type: 0x08:‘Internal’) |
| | :IE: 0x38 ‘This Device Status’: ‘OffHook’ |
| | :IE: 0x96 ‘Call ID’: 23724244 (0x00D4) (HLOC: 0x016A) |
| | :IE: 0x5F ‘Enhanced Time Stamp’: - 13:36:00 |
| E7 | :M0: e5 H<-L: Unsolicited-StatusChange (2661,23724244,‘OffHook’) |
| | :M1: ------------------------------------------------------------------------- |
| E8 | :M1: 0xFF 0A 00 24 10 00 00 08 0F 00 37 04 04 8A 36 08 00 08 32 36 |
| | 36 31 38 03 02 96 06 01 6A 00 D4 5F 05 0D 24 00 |
| E9 | :m1: CALL REC - CallRecGetState. No Call Record found. Assumed new call |
| | and returned state:Idle for CallID:23724244 |
| E10 | :m1: CALL REC - New CallRecord created for CallID:23724244, e5. |
| E11 | :m1: CALL REC - set OrigDN:2661, TN:4,0,2,10 for CallID:23724244. |
| E12 | :m0: CSTA-ServiceInitiated(e5) initiatedConn:2661-23724244. |
| | [HTD] -------- Outgoing Event --------> |
| E13 | [HT_MsgTypeEvent] { |
| | [HT_TokenVersion:“HT CSTA 1.0”] |
| | [HT_TokenEvent:HT_EventServiceInitiated] |
| | [HT_TokenCause:HT_CauseNull] |
| | [HT_TokenLocalConnectionState:HT_ConnectionStateNull] |
| E13L6 | [HT_TokenEventNumber:5] |
| | [HT_TokenSubjectDevice:“2661”] |
| | [HT_TokenConnection] { |
| | [HT_TokenCallID:23724244] |
| | [HT_TokenDeviceID:“2661”] |
| | } |
| | [HT_TokenMonitorID:1] |
| | } |
| | [HTD] -------- Outgoing Event --------> |
| E14 | :m1: DEVICE - DN:2661 returned ReqID:2. |
| E15 | :m1: CALL REC - Call State changed from Idle to CTIPending for |
| | CallID:23724244. |
| E16 | :m2: INIT - mlProcessSocket: got input |
| | :M1: |

E6

In stage two, the protocol converter 36 has responded to receipt of a hexadecimal message from the PBX 12 by creating an “M1” entry (Link-NewMsgTimeStamp), labelled E6, in respect of the time of receipt of that message from the PBX 12; by according that received hexadecimal message the importance level “1”; by interpreting the byte values and creating corresponding IE entries; by incrementing the 32 bit counter 38 to a new counter value of “5”; by creating a corresponding “M0” entry, labelled E7, into which it has inserted, at low level, four bytes corresponding to this value, together with the alpha character “e”, in its ASCII format, as the corresponding message identifier “e5” in respect of that received hexadecimal message; and by storing that received hexadecimal message as an “M1” entry, labelled E8.

From the received hexadecimal message (E8) and its associated IE entries, it can be seen that the PBX 12 has allocated a CallID “23724244”, and has reported that the status of the telephone 2661 is “Offhook”. Accordingly, the plain language text of the corresponding “M0” entry is “Unsolicited-StatusChange (2661,23724244,“Offhook”)”.

The protocol converter 36 further responds to receipt of that hexadecimal message by checking the call record store 40 to see whether there is an existing call record containing that CallID. In the present example of a new call, no such existing call record was found, and the protocol converter 36 creates the “m1” entry, labelled E9, containing the plain language text “CALL REC—CallRecGetState. No Call Record found. Assumed new call and returned state:Idle for CallID:23724244”. It will be noted that the current state is Idle.

The protocol converter 36 now responds to no call record being found by creating a new call record for that CallID 23724244, and storing a corresponding “m1” entry, labelled E10, containing the message identity “e5” to associate it with the received hexadecimal message for this call. Having created the new record, the protocol converter 36 enters in the appropriate fields the values of the DN 2661, the terminal number (TN) 4,0,2,10, and creates a corresponding “m1” entry, labelled E11, and a corresponding “m0” entry, labelled E12, containing the plain language text “CSTA-ServiceInitiated(e5) initiatedConn:2661-23724244”. It will be noted that this also contains the message identity “e5”.

The protocol converter 36 has, in accordance with its operating program, ascertained that it is to convert that received hexadecimal message into a corresponding CSTA message and send it via a dispatcher, also referred to as a distributor, and the data link 24 to the CTI server 22; made a corresponding log entry, labelled E13; corresponding “m1” entries, labelled E14 and E15, the latter containing the plain language text “CALL REC—Call State changed from Idle to CTIPending for CallID:23724244”; and also a corresponding “m2” entry, labelled E16, containing the plain language text “INIT—mIProcessSocket: got input”. In addition to including the message identity “e5” in the entries E6 to E8, it will be seen that the protocol converter 36 has included an additional line at a standard location, line 6, in that CSTA message sent to the CTI server 22. That additional line, labelled E13L6, contains the plain language text “[HT_TokenEventNumber:5]”.

In variants, there are multiple clients and multiple applications servers with respective data links to the switch driver 18, and the dispatcher will ascertain from requests received from the clients which CSTA messages, if any, have to be dispatched to which clients.

It will be appreciated that the above “m2” entry relates to the fact that data has been received at a particular socket, and as such will be of less interest to the system operator than the higher importance entries. Hereafter, such entries will not be commented upon.

Stage three.

| | |
|---|---|
| | :M1: |
| | \hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| E17 | :M1: e6 \hat{ }\hat{ }\hat{ }\hat{ }\hat{ }\hat{ } Link-NewMsgTimeStamp:13:47:38 2001-02-09 \hat{ }\hat{ }\hat{ }\hat{ }\hat{ }1.1*.0*\hat{ } |
| | :M1: |
| | \hat{ }\hat{ }\hat{ }\hat{ }\hat{ } Creation:13:44:33 2001-02-09, Connection:13:44:43 2001-02-09 \hat{ }\hat{ }\hat{ }\hat{ }\hat{ } |
| | :M1: |
| | \hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :IE: ‘StatusChange’ |
| | :IE: 0xFF ‘Message Header’: MsgLen 48, AssocID 16, Ref 0x0000 |
| | :IE: 0x37 ‘This Device TN’: 0x0489 (004 0 02 09) |
| | :IE: 0x36 ‘This Device DN’: 2660 (Type: 0x08:‘Internal’) |
| | :IE: 0x38 ‘This Device Status’: ‘Ringing’ |
| | :IE: 0x3A ‘Other Device TN’: 0x048A (004 0 02 10) |
| | :IE: 0x39 ‘Other Device DN’: 2661 (Type: 0x08:‘Internal’) |
| | :IE: 0x96 ‘Call ID’: 23724244 (0x00D4) (HLOC: 0x016A) |
| | :IE: 0x5F ‘Enhanced Time Stamp’: - 13:36:00 |
| E18 | :M0: e6 H<-L: Unsolicited-StatusChange (2660,23724244,‘Ringing’) |
| | :M1: --------------------------------------------------------------------------- |
| E19 | :M1: 0xFF 0A 00 30 10 00 00 08 0F 00 37 04 04 89 36 08 00 08 32 36 36 |
| | 30 38 03 03 3A 04 04 8A 39 08 00 08 32 36 36 31 96 06 01 6A 00 |
| | D4 5F 05 0D 24 00 |
| | :m1: CALL REC - CallRecGetState returned state:CTIPending for |
| | CallID:23724244 |
| E20 | :m1: STATE:CTIPending ignore e6. |
| | :m2: INIT - mlProcessSocket: got input |
| | :M1: |

In stage three, the protocol converter 36 has responded to receipt of another hexadecimal message from the PBX 12 by creating an “M1” entry (Link-NewMsgTimeStamp), labelled E17, in respect of the time of receipt of that message from the PBX 12; by according that received hexadecimal message the importance level “1”; by interpreting the byte values and creating corresponding IE entries; by incrementing the counter 38 to a new counter value of “6”; by creating a corresponding “M0” entry, labelled E18, containing the plain language text “H<-L: Unsolicited-StatusChange (2660,23724244,‘Ringing’)” and into which it has inserted the corresponding message identifier “e6” in respect of that received hexadecimal message; and by storing that received hexadecimal message as an “M1” entry, labelled E19.

The protocol converter 36 further responds to receipt of that hexadecimal message by retrieving the current state of the call record for that CallID, and referring to its operating program to see if any action is required. In the present example, the CTI server 22 has not made any request of the protocol converter 36 to be informed that the call is still in the state CTIPending. Accordingly, the protocol converter 36 creates an “m1” entry, labelled E20, containing the plain language text “STATE:CTIPending ignore e6” to denote that it has ignored that received hexadecimal message for conversion purposes.

Stage four.

| | |
|---|---|
| | :M1: |
| | \hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :M1: e7 \hat{ }\hat{ }\hat{ }\hat{ }\hat{ }\hat{ } Link-NewMsgTimeStamp:13:47:38 2001-02-09 |
| | \hat{ }\hat{ }\hat{ }\hat{ }\hat{ }1.1*.0*\hat{ } |
| | :M1: \hat{ }\hat{ }\hat{ }\hat{ }\hat{ } Creation:13:44:33 2001-02-09, Connection:13:44:43 2001-02-09 \hat{ }\hat{ }\hat{ }\hat{ }\hat{ } |
| | :M1: |
| | \hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :IE: ‘Progress’ |
| | :IE: 0xFF ‘Message Header’: MsgLen 43, AssocID 16, Ref 0x8011 |
| | :IE: 0x30 ‘Origination Address’: 2661 (Type: 0x08:‘Internal’) |
| | :IE: 0x31 ‘Destination Address’: 2660 (Type: 0x08:‘Internal’) |
| | :IE: Dumping: IE 0x35, ‘Event’, (Len: 3) 0x35 03 01 |
| E23 | :IE: 0x2E ‘Connection Status’: ‘Called party ringing (multiple |
| | appearance DN)’ |
| | :IE: 0x3F ‘Origination TN’: 0x048A (004 0 02 10) |
| | :IE: 0x96 ‘Call ID’: 23724244 (0x00D4) (HLOC: 0x016A) |
| E22 | :M0: e7 H<-L: Unsolicited-Progress (2661, 2660, Called party ringing |
| | (multiple appearance DN)) |
| | :M1: --------------------------------------------------------------------------- |
| E21 | :M1: 0xFF 0A 00 2B 10 80 11 08 08 01 30 08 00 08 32 36 36 31 31 08 00 |
| | 08 32 36 36 30 35 03 01 2E 04 00 0A 3F 04 04 8A 96 06 01 6A 00 |
| | D4 |
| | :m0: responseSwMsgRefID:0x0011 |
| | :m1: DEVICE - responseSwMsgRefID:0x0011 returned |
| | request:HT_RequestMakeCall. |
| | :m1: DEVICE - DN:2661 returned ReqID:2. |
| | :m1: DEVICE - 2661 returned request:HT_RequestMakeCall. |
| | :m1: Device - Freed DN:2661 and returned ReqID:2. |
| | :m0: CSTA-MakeCallResult(fabricated)(e7) initiatedConn:2661-23724244, |
| | ReqID:2. |
| | [HTD] -------- Outgoing Response --------> |
| E24 | [HT_MsgTypeResponse] { |
| | [HT_TokenVersion:“HT CSTA 1.0”] |
| | [HT_TokenRequest:HT_RequestMakeCall] |
| | [HT_TokenResponse:HT_ResponseSuccess] |
| | [HT_TokenRequestID:919191] |
| | [HT_TokenConnection] { |
| | [HT_TokenCallID:23724244] |
| | [HT_TokenDeviceID:“2661”] |
| | } |
| | } |
| | [HTD] -------- Outgoing Response --------> |
| | :m1: CALL REC - CallRecGetState returned state:CTIPending for |
| | CallID:23724244 |
| | :m1: CALL REC - set CalledDN:2660 for CallID:23724244. |
| E27 | :m0: CSTA-Originated(fabricated:7) subjDev:2661, origConn:2661- |
| | 23724244, callingDev:2661, calledDev:2660 |
| | [HTD] -------- Outgoing Event --------> |
| E26 | [HT_MsgTypeEvent] { |
| | [HT_TokenVersion:“HT CSTA 1.0”] |
| | [HT_TokenEvent:HT_EventOriginated] |
| | [HT_TokenCause:HT_CauseNull] |
| | [HT_TokenLocalConnectionState:HT_ConnectionStateNull] |
| E26L6 | [HT_TokenEventNumber:7] |
| | [HT_TokenSubjectDevice:“2661”] |
| | [HT_TokenConnection] { |
| | [HT_TokenCallID:23724244] |
| | [HT_TokenDeviceID:“2661”] |
| | } |
| | [HT_TokenCallingDevice:“2661”] |
| | [HT_TokenCalledDevice:“2660”] |
| | [HT_TokenMonitorID:1] |
| | } |
| | [HTD] -------- Outgoing Event --------> |
| | :m1: CALL REC - Call State changed from CTIPending to CTIOriginated for |
| | CallID:23724244. |
| | :m1: STATE - Re-entering state machine for same event, e7. |
| | :m1: CALL REC - CallRecGetState returned state:CTIOriginated for |
| | CallID:23724244 |
| | :m1: CALL REC - setTermDev-DN:2660, TN:0,0,0,0, RM:r0m0 for |
| | CallID:23724244. |
| E29 | :m0: CSTA-Delivered(e7) subjDev:2661, conn:2660-23724244, |
| | altingDev:2660, callingDev:2661 calledDev:2660 |
| | [HTD] -------- Outgoing Event --------> |
| E28 | [HT_MsgTypeEvent] { |
| | [HT_TokenVersion:“HT CSTA 1.0”] |
| | [HT_TokenEvent:HT_EventDelivered] |
| | [HT_TokenCause:HT_CauseNull] |
| | [HT_TokenLocalConnectionState:HT_ConnectionStateNull] |
| E28L6 | [HT_TokenEventNumber:7] |
| | [HT_TokenSubjectDevice:“2661”] |
| | [HT_TokenConnection] { |
| | [HT_TokenCallID:23724244] |
| | [HT_TokenDeviceID:“2660”] |
| | } |
| | [HT_TokenAlertingDevice:“2660”] |
| | [HT_TokenCallingDevice:“2661”] |
| | [HT_TokenCalledDevice:“2660”] |
| | [HT_TokenLastRedirectionDevice:“2660”] |
| | [HT_TokenMonitorID:1] |
| | } |
| | [HTD]-------- Outgoing Event --------> |
| E31 | :m0: CSTA-Delivered(e7) subjDev:2660, conn:2660-23724244, |
| | altingDev:2660, callingDev:2661 calledDev:2660 |
| | [HTD] -------- Outgoing Event --------> |
| E30 | [HT_MsgTypeEvent] { |
| | [HT_TokenVersion:“HT CSTA 1.0”] |
| | [HT_TokenEvent:HT_EventDelivered] |
| | [HT_TokenCause:HT_CauseNull] |
| | [HT_TokenLocalConnectionState:HT_ConnectionStateNull] |
| E30L6 | [HT_TokenEventNumber:7] |
| | [HT_TokenSubjectDevice:“2660”] |
| | [HT_TokenConnection] { |
| | [HT_TokenCallID:23724244] |
| | [HT_TokenDeviceID:“2660”] |
| | } |
| | [HT_TokenAlertingDevice:“2660”] |
| | [HT_TokenCallingDevice:“2661”] |
| | [HT_TokenCalledDevice:“2660”] |
| | [HT_TokenLastRedirectionDevice:“2660”] |
| | [HT_TokenMonitorID:1] |
| | } |
| | [HTD] -------- Outgoing Event --------> |
| E32 | :m1: CALL REC - Call State changed from CTIOriginated to |
| | CTIAwaitEstablished for CallID:23724244. |
| | :m2: INIT - mlProcessSocket: got input |
| | :M1: |

The salient features of stage four are the entry, labelled E21, in respect of a received Progress message from the PBX 12 resulting from the called party, i.e. telephone 2660, now receiving a ringing alert signal; the corresponding “M0” entry, labelled E22, containing the plain language text “H<-L: Unsolicited-Progress (2661, 2660, Called party ringing (multiple appearance DN))” and the message identity “e7”; one of the IE entries, labelled E23, containing the plain language text “‘Connection Status’: ‘Called party ringing (multiple appearance DN)’”; the entry, labelled E24, in respect of a ResponseSuccess CSTA message sent to the CTI server 22; the corresponding “m0” entry, labelled E25, and containing the plain language text “CSTA-MakeCallResult(fabricated)(e7) initiatedConn:2661-23724244, ReqID:2”; the entry, labelled E26, in respect of an EventOriginated CSTA message sent to the CTI server 22; the corresponding “m0” entry, labelled E27, and containing the plain language text “CSTA-Originated(fabricated:7) subjDev:2661, origConn:2661-23724244, callingDev:2661, calledDev:2660”; the entry, labelled E28, in respect of an EventDelivered CSTA message sent to the CTI server 22 and relating to Device 2661; the corresponding “m0” entry, labelled E29, and containing the plain language text “CSTA-Delivered(e7) subjDev:2661, conn:2660-23724244, altingDev:2660, callingDev:2661 calledDev:2660”; the entry, labelled E30, in respect of an EventDelivered CSTA message sent to the CTI server 22 and relating to Device 2660, the corresponding “m0” entry, labelled E31, containing the plain language text “CSTA-Delivered(e7) subjDev:2660, conn:2660-23724244, altingDev:2660, callingDev:2661 calledDev:2660”; and the “m1” entry, labelled E32, indicating that the call record has been updated from CTIOriginated to CTIAwaitEstablished for this call.

This stage four has produced a large number of driver log entries, namely, one “M0” entry, two “M1” entries, six “m0” entries, eleven “m1” entries and one “m2” entry. Thus, it can be seen that out of a total of twenty one entries the present invention will select only seven “0” level entries in the report, shown later. Not only is this a more manageable number of entries, but they are limited to the high level significant entries, in that particular report, so as to enhance human understanding of the call processing.

It will be noted that the additional lines, labelled E26L6, E28L6 and E30L6, all contain the plain language text “[HT_TokenEventNumber:7]”.

Stage five.

| | |
|---|---|
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :M1: e8 \hat{ }\hat{ }\hat{ }\hat{ }\hat{ }\hat{ } Link-NewMsgTimeStamp:13:47:38 2001-02-09 |
| | \hat{ }\hat{ }\hat{ }\hat{ }\hat{ }1.1*.0*\hat{ } |
| | :M1: \hat{ }\hat{ }\hat{ }\hat{ }\hat{ } Creation:13:44:33 2001-02-09, Connection:13:44:43 2001-02-09 \hat{ }\hat{ }\hat{ }\hat{ }\hat{ } |
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :IE: ‘StatusChange’ |
| | :IE: 0xFF ‘Message Header’: MsgLen 36, AssocID 16, Ref 0x0011 |
| | :IE: 0x37 ‘This Device TN’: 0x0489 (004 0 02 09) |
| | :IE: 0x36 ‘This Device DN’: 2660 (Type: 0x08:‘Internal’) |
| E35 | :IE: 0x38 ‘This Device Status’: ‘OffHook’ |
| | :IE: 0x96 ‘Call ID’: 23724244 (0x00D4) (HLOC: 0x016A) |
| | :IE: 0x5F ‘Enhanced Time Stamp’: - 13:36:10 |
| E34 | :M0: e8 H <-L: Unsolicited-StatusChange (2660,23724244,‘OffHook’) |
| | :M1: --------------------------------------------------------------------------- |
| E33 | :M1: 0xFF 0A 00 24 10 00 11 08 0F 00 37 04 04 89 36 08 00 08 32 36 36 |
| | 30 38 03 02 96 06 01 6A 00 D4 5F 05 0D 24 0A |
| E36 | :m1: CALL REC - CallRecGetState returned state:CTIAwaitEstablished for |
| | CallID:23724244 |
| | :m2: INIT - mlProcessSocket: got input |
| | :M1: |

The salient features of stage five are the entry, labelled E33, in respect of a received StatusChange message from the PBX 12 resulting from the called party, i.e. telephone 2660, going off hook; the corresponding “M0” entry, labelled E34, containing the plain language text “H<-L: Unsolicited-StatusChange (2660,23724244,‘OffHook’)” and the message identity “e8”; one of the IE entries, labelled E35, containing the plain language text “‘This Device Status’: ‘OffHook’”; the corresponding “m0” entry, labelled E36, and containing the plain language text “CALL REC—CallRecGetState returned state:CTIAwaitEstablished for CallID:23724244”.

Stage six.

| | |
|---|---|
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :M1: e9 \hat{ }\hat{ }\hat{ }\hat{ }\hat{ }\hat{ } Link-NewMsgTimeStamp:13:47:38 2001-02-09 |
| | \hat{ }\hat{ }\hat{ }\hat{ }\hat{ }1.1*.0*\hat{ } |
| | :M1: \hat{ }\hat{ }\hat{ }\hat{ }\hat{ } Creation:13:44:33 2001-02-09, Connection:13:44:43 2001-02-09 \hat{ }\hat{ }\hat{ }\hat{ }\hat{ } |
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :IE: ‘StatusChange’ |
| | :IE: 0xFF ‘Message Header’: MsgLen 48, AssocID 16, Ref 0x0011 |
| | :IE: 0x37 ‘This Device TN’: 0x0489 (004 0 02 09) |
| | :IE: 0x36 ‘This Device DN’: 2660 (Type: 0x08:‘Internal’) |
| E39 | :IE: 0x38 ‘This Device Status’: ‘Active’ |
| | :IE: 0x3A ‘Other Device TN’: 0x048A (004 0 02 10) |
| | :IE: 0x39 ‘Other Device DN’: 2661 (Type: 0x08:‘Internal’) |
| | :IE: 0x96 ‘Call ID’: 23724244 (0x00D4) (HLOC: 0x016A) |
| | :IE: 0x5F ‘Enhanced Time Stamp’: - 13:36:10 |
| E38 | :M0: e9 H <-L: Unsolicited-StatusChange (2660,23724244,‘Active’) |
| | :M1: --------------------------------------------------------------------------- |
| E37 | :M1: 0xEF 0A 00 30 10 00 11 08 0F 00 37 04 04 89 36 08 00 08 32 36 36 |
| | 30 38 03 04 3A 04 04 8A 39 08 00 08 32 36 36 31 96 06 01 6A 00 |
| | D4 5F 05 0D 24 0A |
| | :m1: CALL REC - CallRecGetState returned state:CTIAwaitEstablished for |
| | CallID:23724244 |
| E40 | :m1: STATE:CTIAwaitEstablished ignore e9. |
| | :m2: INIT - mlProcessSocket: got input |
| | :M1: |

The salient features of stage six are the entry, labelled E37, in respect of a received StatusChange message from the PBX 12 resulting from the PBX 12 according an active status to the telephone 2660; the corresponding “M0” entry, labelled E38, containing the plain language text “H<-L: Unsolicited-StatusChange (2660,23724244,‘Active’)” and the message identity “e9”; one of the IE entries, labelled E39, containing the plain language text “‘This Device Status’: ‘Active’”; and one of the corresponding “m1” entries, labelled E40, containing the plain language text “STATE:CTIAwaitEstablished ignore” and the message identity “e9”.

This stage six relates only to the called telephone 2660 being accorded Active status, and the CTI server 22 has not asked to be informed about that situation, hence the entry E40 indicating that the protocol driver 36 has “ignored” the incoming message from the PBX 12, i.e. has not converted it into an outgoing CSTA message.

Stage seven.

| | |
|---|---|
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :M1: e10 \hat{ }\hat{ }\hat{ }\hat{ }\hat{ }\hat{ } Link-NewMsgTimeStamp:13:47:38 2001-02-09 |
| | \hat{ }\hat{ }\hat{ }\hat{ }\hat{ }1.1*.0*\hat{ } |
| | :M1: \hat{ }\hat{ }\hat{ }\hat{ }\hat{ } Creation:13:44:33 2001-02-09, Connection:13:44:43 2001-02-09 \hat{ }\hat{ }\hat{ }\hat{ }\hat{ } |
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :IE: ‘StatusChange’ |
| | :IE: 0xFF ‘Message Header’: MsgLen 48, AssocID 16, Ref 0x0011 |
| | :IE: 0x37 ‘This Device TN’: 0x048A (004 0 02 10) |
| | :IE: 0x36 ‘This Device DN’: 2661 (Type: 0x08:‘Internal’) |
| E43 | :IE: 0x38 ‘This Device Status’: ‘Active’ |
| | :IE: 0x3A ‘Other Device TN’: 0x0489 (004 0 02 09) |
| | :IE: 0x39 ‘Other Device DN’: 2660 (Type: 0x08:‘Internal’) |
| | :IE: 0x96 ‘Call ID’: 23724244 (0x00D4) (HLOC: 0x016A) |
| | :IE: 0x5F ‘Enhanced Time Stamp’: - 13:36:10 |
| E42 | :M0: e10 H <-L: Unsolicited-StatusChange (2661,23724244,‘Active’) |
| | :M1: --------------------------------------------------------------------------- |
| E41 | :M1: 0xFF 0A 00 30 10 00 11 08 0F 00 37 04 04 8A 36 08 00 08 32 36 |
| | 36 31 38 03 04 3A 04 04 89 39 08 00 08 32 36 36 30 96 06 01 6A |
| | 00 D4 5F 05 0D 24 0A |
| | :m1: CALL REC - CallRecGetState returned state: CTIAwaitEstablished for |
| | CallID:23724244 |
| E44 | :m1: STATE:CTIAwaitEstablished ignore e10. |
| | :m2: INIT - mlProcessSocket: got input |
| | :M1: |

The salient features of stage seven are the entry, labelled E41, in respect of a received StatusChange message from the PBX 12 resulting from the PBX 12 according an active status to the telephone 2661; the corresponding “M0” entry, labelled E42, containing the plain language text “H<-L: Unsolicited-StatusChange (2661,23724244,‘Active’)” and the message identity “e10”; one of the IE entries, labelled E43, containing the plain language text “‘This Device Status’: ‘Active’”; and one of the corresponding “m1” entries, labelled E44, containing the plain language text “STATE:CTIAwaitEstablished ignore” and the message identity “e10”.

This stage seven relates only to the calling telephone 2661 being accorded Active status, and the CTI server 22 has not asked to be informed about that situation, hence the entry E44 indicating that the protocol driver 36 has “ignored” the incoming message from the PBX 12, i.e. has not converted it into an outgoing CSTA message.

Stage eight.

| | |
|---|---|
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :M1: e11 \hat{ }\hat{ }\hat{ }\hat{ }\hat{ }\hat{ } Link-NewMsgTimeStamp:13:47:38 2001-02-09 |
| | \hat{ }\hat{ }\hat{ }\hat{ }\hat{ }1.1*.0*\hat{ } |
| | :M1: \hat{ }\hat{ }\hat{ }\hat{ }\hat{ } Creation:13:44:33 2001-02-09, Connection:13:44:43 2001-02-09 \hat{ }\hat{ }\hat{ }\hat{ }\hat{ } |
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :IE: ‘Progress’ |
| | :IE: 0xFF ‘Message Header’: MsgLen 47, AssocID 16, Ref 0x8011 |
| | :IE: 0x30 ‘Origination Address’: 2661 (Type: 0x08:‘Internal’) |
| | :IE: 0x31 ‘Destination Address’: 2660 (Type: 0x08:‘Internal’) |
| | :IE: Dumping: IE 0x35, ‘Event’, (Len: 3) 0x35 03 03 |
| E47 | :IE: 0x2E ‘Connection Status’: ‘Called party answered’ |
| | :IE: 0x3F ‘Origination TN’: 0x048A (004 0 02 10) |
| | :IE: 0x40 ‘Destination TN’: 0x0489 (004 0 02 09) |
| | :IE: 0x96 ‘Call ID’: 23724244 (0x00D4) (HLOC: 0x016A) |
| E46 | :M0: e11 H <-L: Unsolicited-Progress (2661, 2660, Called party answered) |
| | :M1: --------------------------------------------------------------------------- |
| E45 | :M1: 0xFF 0A 00 2F 10 80 11 08 08 01 30 08 00 08 32 36 36 31 31 08 00 |
| | 08 32 36 36 30 35 03 03 2E 04 01 01 3F 04 04 8A 40 04 04 89 96 |
| | 06 01 6A 00 D4 |
| | :m0: responseSwMsgRefID: 0x0011 |
| | :m1: Device - deviceReturnReqID - ReqID not found for DN: 2661. |
| | :m1: CALL REC - CallRecGetState returned state: CTIAwaitEstablished for |
| | CallID: 23724244 |
| | :m1: CALL REC - set TermDN:2660 (fromDN:2660) for CallID:23724244. |
| E49 | :m0: CSTA-Established(e11) subjDev:2661, estabConn:2660-23724244, |
| | altingDev:2660, callingDev:2661 calledDev:2660 |
| | [HTD] -------- Outgoing Event --------> |
| E48 | [HT_MsgTypeEvent] { |
| | [HT_TokenVersion:“HT CSTA 1.0”] |
| | [HT_TokenEvent:HT_EventEstablished] |
| | [HT_TokenCause:HT_CauseNull] |
| | [HT_TokenLocalConnectionState:HT_ConnectionStateNull] |
| E48L6 | [HT_TokenEventNumber:11] |
| | [HT_TokenSubjectDevice:“2661”] |
| | [HT_TokenConnection] { |
| | [HT_TokenCallID:23724244] |
| | [HT_TokenDeviceID:“2660”] |
| | } |
| | [HT_TokenAnsweringDevice:“2660”] |
| | [HT_TokenCallingDevice:“2661”] |
| | [HT_TokenCalledDevice:“2660”] |
| | [HT_TokenLastRedirectionDevice: “2660”] |
| | [HT_TokenMonitorID:1] |
| | } |
| | [HTD] -------- Outgoing Event --------> |
| E51 | :m0: CSTA-Established(e11) subjDev:2660, estabConn:2660-23724244, |
| | altingDev: 2660, callingDev:2661 calledDev:2660 |
| | [HTD] -------- Outgoing Event --------> |
| E50 | [HT_MsgTypeEvent] { |
| | [HT_TokenVersion:“HT CSTA 1.0”] |
| | [HT_TokenEvent:HT_EventEstablished] |
| | [HT_TokenCause:HT_CauseNull] |
| | [HT_TokenLocalConnectionState:HT_ConnectionStateNull] |
| E50L6 | [HT_TokenEventNumber:11] |
| | [HT_TokenSubjectDevice:“2660”] |
| | [HT_TokenConnection] { |
| | [HT_TokenCallID:23724244] |
| | [HT_TokenDeviceID:“2660”] |
| | } |
| | [HT_TokenAnsweringDevice:“2660”] |
| | [HT_TokenCallingDevice:“2661”] |
| | [HT_TokenCalledDevice:“2660”] |
| | [HT_TokenLastRedirectionDevice:“2660”] |
| | [HT_TokenMonitorID:1] |
| | } |
| | [HTD] -------- Outgoing Event --------> |
| | :m1: CALL REC - Call State changed from CTIAwaitEstablished to Established |
| | for CallID:23724244. |
| | :m1: CALL REC - set EstabDev[0]-DN:2661 TN:4,0,2,10 RM:r0m0, for |
| | CallID:23724244. |
| | :m1: CALL REC - set EstabDev[1]-DN:2660 TN:0,0,0,0 RM:r0m0, for |
| | CallID:23724244. |
| | :m2: INIT - mlProcessSocket: got input |
| | :M1: |

The salient features of stage eight are the entry, labelled E45, in respect of a received Progress message from the PBX 12 resulting from the telephone 2660 going off hook; the corresponding “M0” entry, labelled E46, containing the plain language text “H<-L: Unsolicited-Progress (2661, 2660, 23724244, Called party answered)” and the message identity “e11 “; one of the IE entries, labelled E47, containing the plain language text “‘Connection Status’: ‘Called party answered’”; the entry, labelled E48, in respect of a first corresponding CSTA message informing the CTI server 22 that the Device 2661 is a party of an established call; the corresponding “m0” entry, labelled E49, containing the plain language text “CSTA-Established(e11) subjDev:2661, estabConn:2660-23724244, altingDev:2660, callingDev:2661 calledDev:2660”; the entry, labelled E50, in respect of a second corresponding CSTA message informing the CTI server 22 that the Device 2660 is a party of an established call; and the corresponding “m0” entry, labelled E51, containing the plain language text “CSTA-Established(e11) subjDev:2660, estabConn:2660-23724244, altingDev:2660, callingDev:2661 calledDev:2660”.

It will be noted that the additional lines, labelled E48L6 and E50L6, both contain the plain language text “[HT_TokenEventNumber:11]”.

Stage nine.

| | |
|---|---|
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :M1: e12 \hat{ }\hat{ }\hat{ }\hat{ }\hat{ }\hat{ } Link-NewMsgTimeStamp:13:47:38 2001-02-09 |
| | \hat{ }\hat{ }\hat{ }\hat{ }\hat{ }1.1*.0*\hat{ } |
| | :M1: \hat{ }\hat{ }\hat{ }\hat{ }\hat{ } Creation:13:44:33 2001-02-09, Connection:13:44:43 2001-02-09 \hat{ }\hat{ }\hat{ }\hat{ }\hat{ } |
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :IE: ‘StatusChange’ |
| | :IE: 0xFF ‘Message Header’: MsgLen 36, AssocID 16, Ref 0x0011 |
| | :IE: 0x37 ‘This Device TN’: 0x0489 (004 0 02 09) |
| | :IE: 0x36 ‘This Device DN’: 2660 (Type: 0x08:‘Internal’) |
| E54 | :IE: 0x38 ‘This Device Status’: ‘OnHook’ |
| | :IE: 0x96 ‘Call ID’: 23724244 (0x00D4) (HLOC: 0x016A) |
| | :IE: 0x5F ‘Enhanced Time Stamp’: - 13:36:16 |
| E53 | :M0: e12 H<-L: Unsolicited-StatusChange (2660,23724244,‘OnHook’) |
| | :M1: --------------------------------------------------------------------------- |
| E52 | :M1: 0xFF 0A 00 24 10 00 11 08 0F 00 37 04 04 89 36 08 00 08 32 36 36 |
| | 30 38 03 01 96 06 01 6A 00 D4 5F 05 0D 24 10 |
| | :m1: CALL REC - CallRecGetState returned state:Established for |
| | CallID:23724244 |
| | :m1: DEVICE - deviceReturnRequest - Request not found for DN:2660. |
| | :m1: CALL REC - CallRecGetState returned state:Established for |
| | CallID:23724244 |
| | :m1: CALL REC - EstDN[1]:2660 TN:0,0,0,0 set to NULL for |
| | CallID:23724244, in CallRecFreeSingleEstablishedParty. |
| E56 | :m0: CSTA-ConnectionCleared(e12) subjDev:2660, droppedConn:2660- |
| | 23724244, releasingDev:2660. |
| | [HTD] -------- Outgoing Event --------> |
| E55 | [HT_MsgTypeEvent] { |
| | [HT_TokenVersion:“HT CSTA 1.0”] |
| | [HT_TokenEvent:HT_EventConnectionCleared] |
| | [HT_TokenCause:HT_CauseNull] |
| | [HT_TokenLocalConnectionState:HT_ConnectionStateNull] |
| E55L6 | [HT_TokenEventNumber:12] |
| | [HT_TokenSubjectDevice:“2660”] |
| | [HT_TokenConnection] { |
| | [HT_TokenCallID:23724244] |
| | [HT_TokenDeviceID:“2660”] |
| | } |
| | [HT_TokenReleasingDevice:“2660”] |
| | [HT_TokenMonitorID:1] |
| | } |
| | [HTD] -------- Outgoing Event --------> |
| E58 | :m0: CSTA - ConnectionCleared(e12) subjDev:2661, droppedConn:2660- |
| | 23724244, releasingDev:2660. |
| | [HTD] -------- Outgoing Event --------> |
| E57 | [HT_MsgTypeEvent] { |
| | [HT_TokenVersion:“HT CSTA 1.0”] |
| | [HT_TokenEvent:HT_EventConnectionCleared] |
| | [HT_TokenCause:HT_CauseNull] |
| | [HT_TokenLocalConnectionState:HT_ConnectionStateNull] |
| E57L6 | [HT_TokenEventNumber:12] |
| | [HT_TokenSubjectDevice:“2661”] |
| | [HT_TokenConnection] { |
| | [HT_TokenCallID:23724244] |
| | [HT_TokenDeviceID:“2660”] |
| | } |
| | [HT_TokenReleasingDevice:“2660”] |
| | [HT_TokenMonitorID:1] |
| | } |
| | [HTD] -------- Outgoing Event --------> |
| | :m1: CALL REC - 1 established party left for CallID:23724244, so reduce |
| | garbage time to 5s. |
| | :m2: INIT - mlProcessSocket: got input |
| | :M1: |

The salient features of stage nine are the entry, labelled E52, in respect of a received StatusChange message from the PBX 12 resulting from telephone 2660 going on hook; the corresponding “M0” entry, labelled E53, containing the plain language text “H<-L: Unsolicited-StatusChange (2660,23724244,‘OnHook’)” and the message identity “e12”; one of the IE entries, labelled E54, containing the plain language text “‘This Device Status’: ‘OnHook’”; the entry, labelled E55, in respect of a first corresponding CSTA message informing the CTI server 22 that the Device 2660 is a “Releasing Device”; the corresponding “m0” entry, labelled E56, containing the plain language text “CSTA-ConnectionCleared(e12) subjDev:2660, droppedConn:2660-23724244, releasingDev:2660”; the entry, labelled E57, in respect of a second corresponding CSTA message informing the CTI server 22 that the Device 2661 is a “Releasing Device”; and the corresponding “m0” entry, labelled E58, containing the plain language text “CSTA-ConnectionCleared(e12) subjDev:2661, droppedConn:2660-23724244, releasingDev:2660”.

It will be noted that the additional lines, labelled E55L6 and E57L6, both contain the plain language text “[HT_TokenEventNumber:12]”.

Stage ten.

| | |
|---|---|
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :M1: e13 \hat{ }\hat{ }\hat{ }\hat{ }\hat{ }\hat{ } Link-NewMsgTimeStamp:13:47:38 2001-02-09 |
| | \hat{ }\hat{ }\hat{ }\hat{ }\hat{ }1.1*.0*\hat{ } |
| | :M1: \hat{ }\hat{ }\hat{ }\hat{ }\hat{ } Creation:13:44:33 2001-02-09, Connection:13:44:43 2001-02-09 \hat{ }\hat{ }\hat{ }\hat{ }\hat{ } |
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :IE: ‘StatusChange’ |
| | :IE: 0xFF ‘Message Header’: MsgLen 36, AssocID 16, Ref 0x0011 |
| | :IE: 0x37 ‘This Device TN’: 0x0489 (004 0 02 09) |
| | :IE: 0x36 ‘This Device DN’: 2660 (Type: 0x08:‘Internal’) |
| E61 | :IE: 0x38 ‘This Device Status’: ‘Disconnect’ |
| | :IE: 0x96 ‘Call ID’: 23724244 (0x00D4) (HLOC: 0x016A) |
| | :IE: 0x5F ‘Enhanced Time Stamp’: - 13:36:16 |
| E60 | :M0: e13 H <-L: Unsolicited-StatusChange (2660,23724244,‘Disconnect’) |
| | :M1: --------------------------------------------------------------------------- |
| E59 | :M1: 0xFF 0A 00 24 10 00 11 08 0F 00 37 04 04 89 36 08 00 08 32 36 36 |
| | 30 38 03 05 96 06 01 6A 00 D4 5F 05 0D 24 10 |
| | :m1: CALL REC - CallRecGetState returned state:Established for |
| | CallID:23724244 |
| | :m1: DEVICE - deviceReturnRequest - Request not found for DN:2660. |
| | :m1: CALL REC - TN:4,0,2,9 not found in CallRecGetEstablishedDNIndex, |
| | CallID:23724244. |
| | :M1: |

The salient features of stage ten are the entry, labelled E59, in respect of a received StatusChange message from the PBX 12 resulting from the PBX 12 according Disconnect status to the telephone 2660; the corresponding “M0” entry, labelled E60, containing the plain language text “H<-L: Unsolicited-StatusChange (2660,23724244,‘Disconnect’)” and the message identity “e13”; one of the IE entries, labelled E61, containing the plain language text “‘This Device Status’: ‘Disconnect’”.

Stage eleven.

| | |
|---|---|
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :M1: e14 \hat{ }\hat{ }\hat{ }\hat{ }\hat{ }\hat{ } Link-NewMsgTimeStamp:13:47:55 2001-02-09 |
| | \hat{ }\hat{ }\hat{ }\hat{ }\hat{ }1.1*.0*\hat{ } |
| | :M1: \hat{ }\hat{ }\hat{ }\hat{ }\hat{ } Creation:13:44:33 2001-02-09, Connection:13:44:43 2001-02- |
| | 09 \hat{ }\hat{ }\hat{ }\hat{ }\hat{ } |
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :IE: ‘StatusChange’ |
| | :IE: OxFF ‘Message Header’: MsgLen 36, AssocID 16, Ref 0x0011 |
| | :IE: 0x37 ‘This Device TN’: 0x048A (004 0 02 10) |
| | :IE: 0x36 ‘This Device DN’: 2661 (Type: 0x08:‘Internal’) |
| E64 | :IE: 0x38 ‘This Device Status’: ‘OnHook’ |
| | :IE: 0x96 ‘Call ID’: 23724244 (0x00D4) (HLOC: 0x016A) |
| | :IE: 0x5F ‘Enhanced Time Stamp’: - 13:36:16 |
| E63 | :M0: e14 H <-L: Unsolicited-StatusChange (2661,23724244,‘OnHook’) |
| | :M1: --------------------------------------------------------------------------- |
| E62 | :M1: 0xFF 0A 00 24 10 00 11 08 0F 00 37 04 04 8A 36 08 00 08 32 36 |
| | 36 31 38 03 01 96 06 01 6A 00 D4 5F 05 0D 24 10 |
| | :m1: CALL REC - CallRecGetState returned state:Established for |
| | CallID:23724244 |
| | :m1: DEVICE - deviceReturnRequest —Request not found for DN:2661. |
| | :m1: CALL REC - CallRecGetState returned state:Established for |
| | CallID:23724244 |
| | :m1: CALL REC - EstDN[0]:2661 TN:4,0,2,10 set to NULL for |
| | CallID:23724244, in CallRecFreeSingleEstablishedParty. |
| E66 | :m0: CSTA-ConnectionCleared(e14) subjDev:2661, droppedConn:2661- |
| | 23724244, releasingDev:2661. |
| | [HTD] -------- Outgoing Event --------> |
| E65 | [HT_MsgTypeEvent] { |
| | [HT_TokenVersion:“HT CSTA 1.0”] |
| | [HT_TokenEvent:HT_EventConnectionCleared] |
| | [HT_TokenCause:HT_CauseNull] |
| | [HT_TokenLocalConnectionState:HT_ConnectionStateNull] |
| E65L6 | [HT_TokenEventNumber:14] |
| | [HT_TokenSubjectDevice:“2661”] |
| | [HT_TokenConnection] { |
| | [HT_TokenCallID:23724244] |
| | [HT_TokenDeviceID:“2661”] |
| | } |
| | [HT_TokenReleasingDevice:“2661”] |
| | [HT_TokenMonitorID:1] |
| | } |
| | [HTD] -------- Outgoing Event --------> |
| | :m1: CALL REC - has zero established parties, CallID:23724244, so free. By- |
| | by. |
| E67 | :m1: CALL REC - CallRecord deleted for CallID:23724244. |
| | :M1: |

The salient features of stage eleven are the entry, labelled E62, in respect of a received StatusChange message from the PBX 12 resulting from telephone 2661 going on hook; the corresponding “M0” entry, labelled E63, containing the plain language text “H<-L: Unsolicited-StatusChange (2661,23724244,‘OnHook’)” and the message identity “e14”; one of the IE entries, labelled E64, containing the plain language text “‘This Device Status’: ‘OnHook’”; the entry, labelled E65, in respect of a corresponding CSTA message informing the CTI server 22 that the Device 2661 is a “Releasing Device”; the corresponding “m0” entry, labelled E66, containing the plain language text “CSTA-ConnectionCleared(e14) subjDev:2661, droppedConn:2661-23724244, releasingDev:2661”; and a corresponding “m1” entry, labelled E67, containing the plain language text “CALL REC—CallRecord deleted for CallID:23724244”.

It will be noted that the additional line, labelled E65L6, contains the plain language text “[HT_TokenEventNumber:14]”.

Stage twelve.

| | |
|---|---|
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :M1: e15 \hat{ }\hat{ }\hat{ }\hat{ }\hat{ }\hat{ } Link-NewMsgTimeStamp:13:47:55 2001-02-09 |
| | \hat{ }\hat{ }\hat{ }\hat{ }\hat{ }1.1*.0*\hat{ } |
| | :M1: \hat{ }\hat{ }\hat{ }\hat{ }\hat{ } Creation:13:44:33 2001-02-09, Connection: |
| | 13:44:43 2001-02-09 \hat{ }\hat{ }\hat{ }\hat{ }\hat{ } |
| | :M1:\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ } |
| | :IE: ‘StatusChange’ |
| | :IE: 0xFF ‘Message Header’: MsgLen 36, |
| | AssocID 16, Ref 0x0011 |
| | :IE: 0x37 ‘This Device TN’: 0x048A (004 0 02 10) |
| | :IE: 0x36 ‘This Device DN’: 2661 (Type: 0x08:‘Internal’) |
| E70 | :IE: 0x38 ‘This Device Status’: ‘Disconnect’ |
| | :IE: 0x96 ‘Call ID’: 23724244 (0x00D4) |
| | (HLOC: 0x016A) |
| | :IE: 0x5F ‘Enhanced Time Stamp’: - 13:36:16 |
| E69 | :M0:e15 H<-L: Unsolicited-StatusChange |
| | (2661,23724244,‘Disconnect’) |
| | :M1: --------------------------------------------------------------------------- |
| E68 | :M1: 0xFF 0A 00 24 10 00 11 08 0F 00 37 04 04 8A 36 |
| | 08 00 08 32 36 36 31 38 03 05 96 |
| | 06 01 6A 00 D4 5F 05 0D 24 10 |
| | :m1: CALL REC - CallRecGetState. No Call Record found. |
| | Assumed new call and returned state: |
| | Idle for CallID:23724244 |
| E70 | :m1: STATE:Idle ignore e15. |

The salient features of stage twelve are the entry, labelled E68, in respect of a received StatusChange message from the PBX 12 resulting from the PBX 12 according Disconnect status to the telephone 2661; the corresponding “M0” entry, labelled E69, containing the plain language text “H<-L: Unsolicited-StatusChange (2661,23724244,‘Disconnect’)” and the message identity “el5”; one of the IE entries, labelled E70, containing the plain language text “‘This Device Status’: ‘Disconnect’”; and one of the “m1” entries, labelled E71, containing the plain language text “STATE:Idle ignore e15”.

The above example of user A making a CTI call to user B is the simplest of a range of call scenarios, and yet it can be seen that this has generated a very large number of entries in the driver log 42. In this example, the call was successfully connected to user B's telephone and subsequently cleared down without any mishap. However, had there been a fault, either software or hardware, which had prevented complete success for that call, then the system operator would note that a fault had been recorded in a fault log, for example the call might not have cleared down properly following the called user going on hook. The fault report might indicate that trouble was experienced for the message having the message identity 13. The system operator would then retrieve the message (E13) and retrieve from that message the call ID (CallID 23724244). Then the system operator would examine the driver log entries, i.e. run a report on the log, for that call ID to find out at what point the call processing had performed incorrectly. This would then enable the system operator to select the appropriate next step for correcting the fault.

If the system operator runs a report which retrieves all entries relating to a call, then the report output, e.g. a printout from Stage two onwards as above, would be difficult to manage and it would not be easy to determine the entry corresponding to the manifestation of the fault. In accordance with the associated importance identifiers described above, the system operator can start by running a report for a call which retrieves only the highest level entries, i.e. the “M0” and “m0” entries. This enables the system operator to understand at high level the progress that the call made through the call processing. If the system operator requires further detail at any stage, he can run a more detailed report, this time retrieving either alternatively or additionally the “M1” and “m1” entries. With regard to the “m2” entries in the log, it is not expected that these will provide any useful information to the system operator, so these are not retrieved by any selective report and will be retrieved only by a full, non-selective report.

The “0” level report run on the above driver log entries for the call ID 23724244 is as follows.

:M0: e5 H<-L: Unsolicited-StatusChange (2661,23724244,‘OffHook’)

:m0: CSTA-ServiceInitiated(e5) initiatedConn:2661-23724244.

:M0: e6 H<-L: Unsolicited-StatusChange (2660,23724244,‘Ringing’)

:M0: e7 H<-L: Unsolicited-Progress (2661, 2660, Called party ringing (multiple appearance DN))

:m0: responseSwMsgRefID:0x0011

:m0: CSTA-MakeCallResult(fabricated)(e7) initiatedConn:2661-23724244, ReqID:2.

:m0: CSTA-Originated(fabricated:7) subjDev:2661, origConn:2661-23724244, callingDev:2661, calledDev:2660

:m0: CSTA-Delivered(e7) subjDev:2661, conn:2660-23724244, altingDev:2660, callingDev:2661 calledDev:2660

:m0: CSTA-Delivered(e7) subjDev:2660, conn:2660-23724244, altingDev:2660, callingDev:2661 calledDev:2660

:M0: e8 H<-L: Unsolicited-StatusChange (2660,23724244,‘OffHook’)

:M0: e9 H<-L: Unsolicited-StatusChange (2660,23724244,‘Active’)

:M0: e10 H<-L: Unsolicited-StatusChange (2661,23724244,‘Active’)

:M0: e11 H<-L: Unsolicited-Progress (2661, 2660, Called party answered)

:m0: responseSwMsgRefID:0x0011

:m0: CSTA-Established(e11) subjDev:2661, estabConn:2660-23724244, altingDev:2660, callingDev:2661 calledDev:2660:m0: CSTA-Established(e11) subjDev:2660, estabConn:2660-23724244, altingDev:2660, callingDev:2661 calledDev:2660:M0: e12 H<-L: Unsolicited-StatusChange (2660,23724244,‘OnHook’)

:m0: CSTA-ConnectionCleared(e12) subjDev:2660, droppedConn:2660-23724244, releasingDev:2660.

:m0: CSTA-ConnectionCleared(e12) subjDev:2661, droppedConn:2660-23724244, releasingDev:2660.

:M0: e13 H<-L: Unsolicited-StatusChange (2660,23724244,‘Disconnect’)

:M0: e14 H<-L: Unsolicited-StatusChange (2661,23724244,‘OnHook’)

:m0: CSTA-ConnectionCleared(e14) subjDev:2661, droppedConn:2661-23724244, releasingDev:2661.

:M0: e15 H<-L: Unsolicited-StatusChange (2661,23724244,‘Disconnect’)

In the driver log there are one hundred and seven entries for stages two to twelve of this call, but only twenty one “0” level entries in the report, and as stated above, this results in greatly increased readability of the events.

In the absence of the present invention, it would be possible to retrieve from the driver log 42 all the one hundred and seven entries relating to the CallID 23724244, but this would not be satisfactory for some PBXs which use a small counter, e.g. 24 bits, for generating the CallID, and recycle the CallIDs frequently. Furthermore, it is less easy, or impossible in the case of recycled CallIDs, to ascertain that the entry

“: H<-L: Unsolicited-StatusChange (2661,23724244,‘OffHook’)”,

i.e. the E7 entry without the message identifier “e5” and the type and importance identifiers “M0”, was associated with the same event, or received message, as the entry

“: CSTA-ServiceInitiated initiatedConn:2661-23724244.”,

i.e. the E12 entry without the message identifier “e5” and the type and importance identifiers “m0”. A further complication arises when the telephones have multiple calls, for example when user B has requested that calls to his telephone 2660 are also to alert one or more of, say, a second telephone on the PBX 12, i.e. an on-switch number, a mobile telephone, and an off-switch number, for example user B's home telephone.

Because both entries E7 and E12 contain the message identifier “e5”, it is a simple matter to deduce that they relate to the same event or message.

Additionally or alternatively to identifying the switch driver 18 by means of the “AssocID 16”, the switch can be allocated a numeric identifier, e.g. “10”, and this can be combined with the message identifier such as to produce a modified identifier “e10:5”, i.e. entry E7 would become

“:M0”: CSTA-ServiceInitiated(e10:5) initiatedConn:2661-23724244.”,

and the modified identifier “e10:5” would be included in line 6 of the CSTA messages sent to the CTI server 22, as well as being incorporated into the “M0” and “m0” entries.

As mentioned above, there may be multiple application servers. In a variant, one or more of these multiple application servers might be operative to indicate an on-hook/off-hook icon on a client graphics user interface (GUI), and the protocol converter 36 can request an application server identifier from the particular application server, or itself allocate such an application server identifier for that particular application server. Then for this situation, the message identifiers will be of the form “e99:10:5”, where “99” is an application server identifier, and as an example, the modified E12 driver log entry would be

:m0: CSTA-ServiceInitiated(e99:10:5) initiatedConn:2661-23724244,

and the log would contain an entry in respect of a displayed icon

:p0: PersonOffHook(e:99:10:4) initiatedConn:2661-23724244.

It will be noted that in this situation, the protocol converter 36 uses a further type identifier “p”.

For the purposes of producing the above printout of the driver log entries for this call scenario, the counter 38 of the switch driver 18 of the Applicant's test CTI system 10 was reset to zero. Furthermore, the example call was made at a time when the PBX was not simultaneously handling other calls, and the numbers allocated to the received messages were sequential. In a CTI system carrying live traffic in, say, the headquarters of a large company, there might be a large number of simultaneously handled calls and the sequence of message identities for the messages of such a call set up will probably not be consecutive.

Instead of a simple numerical count using the 32 bit counter, the sequence of message identifiers can be a non-numeric sequence of symbols or text strings, e.g. “one”, “two”, three”, albeit those symbols or text strings will be handled in the form of bytes or groups of bytes by the protocol converter 36. Furthermore, instead of a counter, there may be a pool of dynamically-reusable identities and the protocol converter 36 can make a random selection from that pool, returning a used identity to the pool after a suitable length of time to reduce the risk that the system operator would be confused by retrieving entries relating to two or more calls which had been allocated the same message identity.

Whereas the specific embodiment described above is based on a switch in the form of a PBX, it will be appreciated that the present invention embraces other forms of switching function. For example, the switch can be a public network switch, such as a Nortel DMS100 switch which is used in known CTI arrangements in conjunction with a CompuCall CTI controller; and other forms of switching function include switches known as Automatic Call Distributor (ACD), Interactive Voice Response (IVR), and server PBX. Furthermore, the type of switching is not limited to any one form, and, in addition to switched circuit technology, includes Asynchronous Transfer Mode (ATM) switching, and Voice over Internet Protocol (VoIP) switching. With regard to this last form of switching, the switch can be a PBX having an Internet Card, or it can be a general purpose computer, e.g. one running Windows NT, having an Internet card, e.g. a Dialogic Internet card, and in this latter case the protocol converter function is provided by a program running in the computer, rather than in a separate protocol converter.

Thus, it can be seen that in general the present invention can be implemented in any computer controlled switch, by means of a suitable controlling program.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A protocol converter for converting messages between a first protocol and a second protocol, the protocol converter comprising converter means responsive to receipt of a first type message in accordance with the first protocol for converting the first type message into a corresponding second type message in accordance with the second protocol, means for generating for the received first type message a respective message receipt identifier, and wherein the converter means is further responsive to said receipt to associate the corresponding second type message with that respective message receipt identifier.

2. A protocol converter as claimed in claim 1, wherein the converter means is further responsive to said receipt to associate the received first type message with that respective message receipt identifier.

3. A protocol converter as claimed in either claim 1 or claim 2, wherein the converter means is further responsive to said receipt to associate the received first type message with a first message type identifier, and the corresponding second type message with a second message type identifier.

4. A protocol converter as claimed in claim 3, wherein the converter means is further responsive to said receipt:
to generate a plurality of information statements, one of said plurality of information statements being a high level description of the overall nature of the first type message and being of highest importance and the or each other information statement being a high level description of a respective component part of the received first type message and being of lower importance; and
to associate with each information statement a respective importance value determined in accordance with predetermined importance criteria.

5. A protocol converter as claimed in any one of claims 1 to 4, further comprising a log, and wherein the converter means is further responsive to said receipt to store in the log the received first type message, the corresponding second type message, and, as the case may be, any information statements, together with, as the case may be, any associated respective message receipt identifier, any respective message type identifier and any respective importance value.

6. A protocol converter as claimed in any one of claims 1 to 5, wherein the converter means performs the association of the respective generated message receipt identifier with the corresponding converted message by appending an additional field to the corresponding converted message and inserting the respective generated message identity into that additional field.

7. A protocol converter as claimed in any one of claims 1 to 6, wherein the identifier generator means is arranged for generating the message receipt identifiers in two-part form, one of said parts being a protocol converter-related identifier, and the other of said parts being a received message-related identifier.

8. A protocol converter substantially as herein described with reference to the drawings.

9. A computer telephony integration (CTI) system comprising a CTI-enabled switch, a CTI controller, and a protocol converter as claimed in any one of claims 1 to 8 disposed to perform protocol conversion upon messages passing between the CTI-enabled switch and the CTI controller, and wherein the CTI-enabled switch operates in accordance with said first protocol, and the CTI controller operates in accordance with said second protocol.

10. A method of converting messages between a first protocol and a second protocol, comprising the steps of:
responding to receipt of a first type message in accordance with the first protocol by converting the first type message into a corresponding second type message in accordance with the second protocol;
generating for the received first type message a respective message receipt identifier; and
associating the corresponding second type message with that respective message receipt identifier.

11. A method as claimed in claim 10, comprising the further step of associating the received first type message with that respective message receipt identifier.

12. A method as claimed in either claim 10 or claim 11, comprising the further step of associating the received first type message with a first message type identifier, and the corresponding second type message with a second message type identifier.

13. A method as claimed in claim 12, comprising the further steps of:
generating, in response to said receipt, a plurality of information statements, one of said plurality of information statements being a high level description of the overall nature of the first type message and being of highest importance and the or each other information statement being a high level description of a respective component part of the received first type message and being of lower importance; and
associating with each information statement a respective importance value determined in accordance with predetermined importance criteria.

14. A method as claimed in any one of claims 10 to 13, comprising the further steps of storing in a log the received first type message, the corresponding second type message, and, as the case may be, any information statements, together with, as the case may be, any associated respective message receipt identifier, any respective message type identifier and any respective importance value.

15. A method as claimed in any one of claims 10 to 14, wherein the step of associating the respective generated message receipt identifier with the corresponding converted message comprises appending an additional field to the corresponding converted message and inserting the respective generated message identity into that additional field.

16. A method as claimed in any one of claims 10 to 15, wherein the step of generating a respective message receipt identifier provides the identifier in two-part form, one of said parts being a protocol converter-related identifier, and the other of said parts being a received message-related identifier.

17. A method of converting messages between a first protocol and a second protocol, the method being substantially as herein described with reference to the drawings.
